(19) United States
(12) Patent Application Publication
(10) Pub. No.: US 2016/0190894 A1
(43) Pub. Date: Jun. 30, 2016

(54) ELECTRIC COMPRESSOR

(71) Applicant: SANDEN HOLDINGS CORPORATION, Isesaki-shi, Gunma (JP)

(72) Inventor: Tetsuya TAKABE, Isesaki-shi, Gunma (JP)

(21) Appl. No.: 14/903,211

(22) PCT Filed: Jul. 10, 2014
(86) PCT No.: PCT/JP2014/068392

§ 371 Date: Jan. 6, 2016

(30) Foreign Application Priority Data
Jul. 12, 2013 (JP) 2013-146194

(51) Int. Cl. H02K 5/22; H02K 11/33; F04C 27/00; F04C 18/02; F04C 29/00

(52) U.S. Cl. CPC H02K 5/22; F04C 18/0215; F04C 29/0085; F04C 27/008; H02K 11/33

(57) ABSTRACT

To provide an electric compressor in which a decrease in sealing performance between a housing and an inverter cover is reduced with electrical connection between the housing and the inverter cover being obtained with stability. In an inverter-integrated electric compressor, a peripheral portion of a metal inverter cover 7 is securely fastened to a metal inverter case 6 constituting a housing of an electric compressor with bolts 8. An annular insulating gasket 9 disposed between the inverter case 6 and the inverter cover 7 seals a gap therebetween. The inverter case 6 and the inverter cover 7 are electrically connected to each other with a projection 63 provided on the inverter case 6. The projection 63 is located toward the interior of the inverter case 6 relative to the bolts 8 and the insulating gasket 9.

### TECHNICAL FIELD

The present invention relates to an electric compressor in which a compression mechanism, an electric motor for driving the compression mechanism, and an inverter for driving the electric motor are integrated.

### BACKGROUND ART

As an electric compressor of this type, an electric compressor disclosed in Patent Document 1 is known, for example. In the electric compressor disclosed in Patent Document 1, a compressing portion and an electric motor are accommodated in a metal housing, and an inverter cover accommodating an inverter for driving the electric motor is fixed to the housing with a bolt. The inverter cover has a metal plate that is arranged to surround the inverter, and an end portion of the metal plate facing the housing has a distal surface that protrudes further toward the housing than a sealing member disposed between the housing and the inverter cover.

The housing and the inverter cover are electrically connected to each other through the bolt and are also electrically connected to each other through a contacting part between the housing and the distal surface of the end portion of the metal plate facing the housing.

### REFERENCE DOCUMENT LIST

### Patent Document

Patent Document 1: Japanese Patent Application Laid-open Publication No. 2012-193660

### SUMMARY OF THE INVENTION

### Problems to be Solved by the Invention

In the electric compressor disclosed in Patent Document 1, however, the end portion of the metal plate facing the housing has a continuous annular shape, and the annular end portion of the metal plate facing the housing is located outside the bolt for fixing the inverter cover to the housing. Thus, a pressing force applied to the sealing member by fixing the bolt has less effect especially on a region outside the end portion facing the housing, so that sealing performance between the housing and the inverter cover might be reduced.

In view of this problem, an object of the present invention is to provide an electric compressor that can reduce a decrease in sealing performance between a housing and an inverter cover while obtaining an electrical connection between the housing and the inverter cover.

### Means for Solving the Problems

According to an aspect of the present invention, an electric compressor includes: a housing made of a metal, configured to accommodate a compression mechanism and an electric motor for driving the compression mechanism, and having an inverter accommodating portion accommodating an inverter for driving the electric motor an inverter cover made of a metal, covering the inverter accommodated in the inverter accommodating portion, and having a peripheral portion securely fastened to the housing with bolts; an insulating sealing member disposed between the housing and the inverter cover and configured to seal a gap between the housing and the inverter cover; and an electrical connecting part configured to electrically connect the housing and the inverter cover to each other, the electrical connecting part being located toward the interior of the inverter accommodating portion relative to the bolts and the insulating sealing member.

### Effects of the Invention

The electric compressor includes the electrical connecting part electrically connecting the housing and the inverter cover to each other. The electrical connecting part is located toward the interior of the inverter accommodating portion relative to the bolts, securely fastening the inverter cover to the housing and the insulating sealing member sealing the gap between the housing and the inverter cover. Thus, electrical connection between the housing and the inverter cover can be obtained with stability, and a decrease in sealing performance between the housing and the inverter cover due to the presence of the electrical connecting part can be reduced.

### BRIEF DESCRIPTION OF THE DRAWINGS

FIG. 1 schematically illustrates a configuration of an electric compressor according to an embodiment.

FIG. 2 is an exploded perspective view illustrating an inverter case and an inverter cover in the electric compressor.

FIG. 3 is an enlarged view illustrating a main portion of the electric compressor.

FIG. 4 is an enlarged cross-sectional view illustrating a main portion of the electric compressor.

### MODE FOR CARRYING OUT THE INVENTION

An embodiment of the present invention will be described with reference to the accompanying drawings.

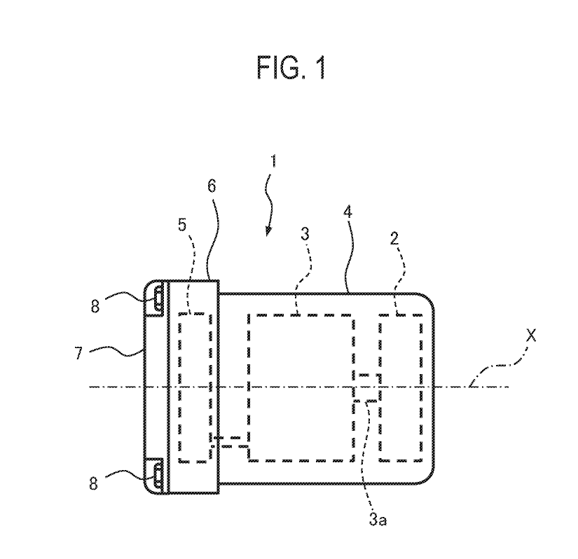

FIG. 1 schematically illustrates an appearance of an electric compressor according to an embodiment of the present invention.

An electric compressor 1 according to this embodiment is provided in a refrigerant circuit of an air-conditioning apparatus of a vehicle, for example, draws refrigerant of the vehicle air-conditioning apparatus, compresses the refrigerant, and discharges the resulting refrigerant. The electric compressor 1 is a so-called inverter-integrated electric compressor, and as illustrated in FIG. 1, includes a main body case 4 accommodating a compression mechanism 2 and an electric motor 3 for driving the compression mechanism 2, and an inverter case (inverter accommodating portion) 6 accommodating an inverter 5 for driving the electric motor 3. The main body case 4 and the inverter case 6 are joined together by a joining means (not illustrated) such as a bolt, and constitute a housing of the electric compressor 1.

In this embodiment, the inverter case 6 is in the shape of a box or a cylinder that has an opening at an end opposite to an end thereof joined to the main body case 4, and the inverter 5 is accommodated (placed) in the inverter case 6 through the opening. The opening of the inverter case 6 is closed with an inverter cover 7, so that the inverter 5 accommodated in the inverter case 6 is covered with the inverter cover 7. Here, a peripheral portion of the inverter cover 7 is securely fastened to the inverter case 6 (i.e., the housing of the electric compressor 1) with bolts 8.

Each of the main body case 4, the inverter case 6, and the inverter cover 7 is made of a metal material such as aluminium. Although not illustrated, the main body case 4 has a suction port and a discharge port of the refrigerant, and the compression mechanism 2 is constituted by a fixed scroll fixed to the main body case 4 and an orbiting scroll disposed opposite to the fixed scroll.

The electric motor 3 is driven by the inverter 5, and drives the compression mechanism 2 (more specifically the orbiting scroll) through a drive shaft 3a thereof. In this manner, the refrigerant (low-pressure refrigerant) is drawn through the suction port and compressed, and the compressed refrigerant (high-pressure refrigerant) is discharged through the discharge port.

The electric compressor 1 is configured to be attached to the vehicle through an attachment part (not illustrated). When the electric compressor 1 is attached to the vehicle, the housing (main body case 4 and/or inverter case 6) of the electric compressor 1 is connected to the ground of the vehicle.

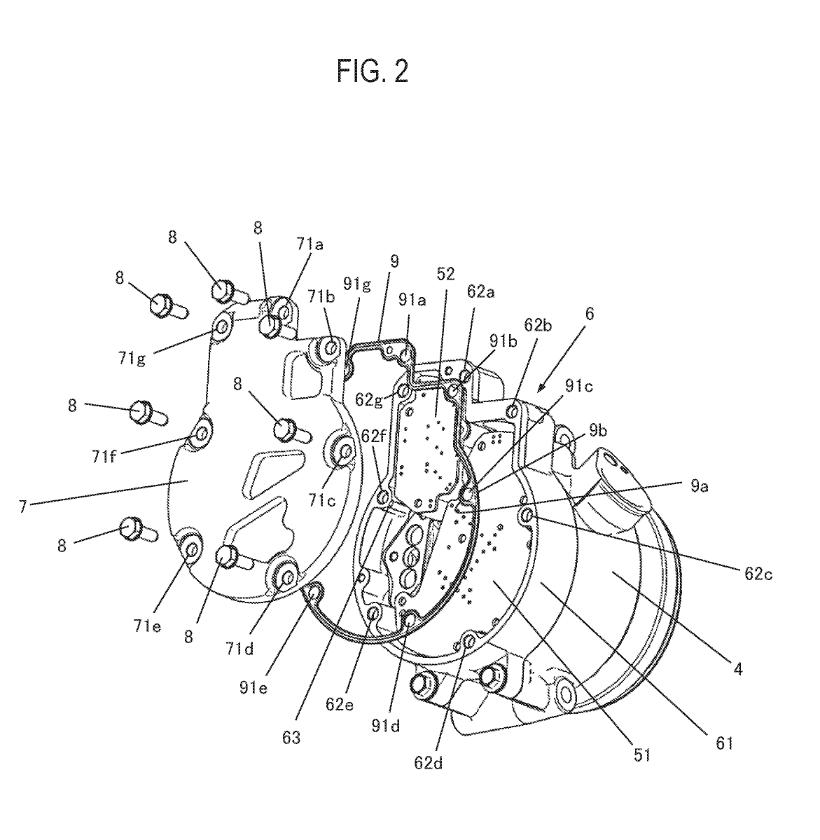

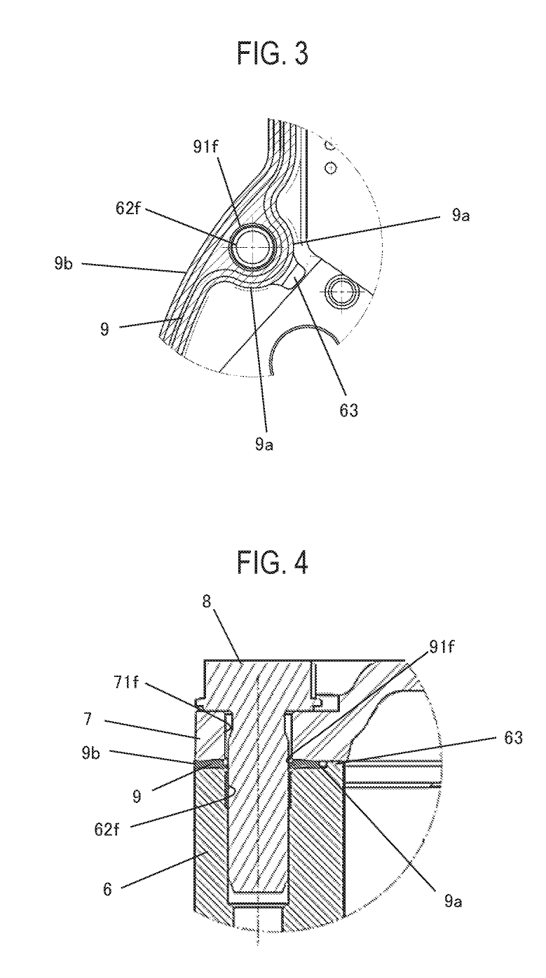

FIG. 2 is an exploded perspective view illustrating the inverter case 6 and the inverter cover 7. FIG. 3 is an enlarged cross-sectional view illustrating a main portion of the electric compressor 1. FIG. 4 is an enlarged cross-sectional view illustrating a main portion of the electric compressor 1.

As illustrated in FIG. 2, the inverter case 6 has an annular peripheral wall 61 extending from and standing on a periphery of the bottom of the inverter case 6. An end surface (distal end surface) of the peripheral wall 61 has a plurality of bolt holes 62 (that are seven bolt holes 62a to 62g in this example) through which the bolts 8 are threaded. Circuit boards 51 and 52 on which electronic components constituting the inverter 5 are mounted are attached and fixed to the inner side of the peripheral wall 61 of the inverter case 6 with screws (not illustrated). That is, in this embodiment, the inverter 5 is accommodated on the inner side of the peripheral wall 61 of the inverter case 6 constituting the housing of the electric compressor 1.

Here, electronic components constituting the inverter 5 are mounted on the two circuit boards 51 and 52 in order to enable efficient and effective antivibration reinforcement, for example, by collecting electronic components susceptible to vibration of components such as a smoothing capacitor and a capacitor for a nozzle filter on one of the circuit boards. However, the present invention is not limited to this example, and all the electronic components constituting the inverter 5 may be mounted on one circuit board so that this circuit board is accommodated in the inverter case 6.

A peripheral portion of the inverter cover 7 has bolt insertion holes 71 (71a to 71g) associated with the bolt holes 62a to 62g formed in the end surface of the peripheral wall 61 of the inverter case 6. The inverter cover 7 is securely fastened to the inverter case 6 with the bolts 8 (seven bolts 8 in this example) through an annular insulating gasket (sealing member) 9 having a shape in conformity with a shape of the end surface of the peripheral wall 61 of the inverter case 6.

In this manner, the insulating gasket 9 is disposed between the housing (inverter case 6) and the inverter cover 7, and is pushed against both the housing and the inverter cover 7 to seal a gap between the housing and the inverter cover 7.

In this embodiment, in a manner similar to the inverter cover 7, the insulating gasket 9 has bolt insertion holes 91 (91a to 91g, where the hole 91f is not illustrated in FIG. 2) associated with the bolt holes 62a to 62g formed in the inverter case 6. The bolts 8 for securely fastening the inverter cover 7 to the inverter case 6 are inserted into the bolt insertion holes 91a to 91g. That is, in a state in which the inverter cover 7 is securely fastened to the housing (inverter case 6) of the electric compressor 1, an inner edge portion 9a of the insulating gasket 9 is located toward the interior of the inverter case 6 relative to the bolts 8, and an outer edge portion 9b of the insulating gasket 9 is located toward the exterior of the inverter case 6 relative to the bolts 8.

Here, in this embodiment, the term “toward the interior of the inverter case 6 relative to the bolts 8” refers to being located inside a loop formed by connecting centers of adjacent bolts 8 (that may be bolt holes 62 or bolt insertion holes 71) along an outer shape of the inverter case 6 (that may be the inverter cover 7). The term “toward the exterior of the inverter case 6 relative to the bolts 8” refers to being located outside the loop.

The inverter cover 7 is electrically connected to the housing of the electric compressor 1 through at least one of the seven bolts 8. Thus, occurrence of a potential difference between the housing and the inverter cover 7 can be prevented, so that mixture and occurrence of noise can be reduced. That is, entering of external noise into the inverter 5 and leakage of noise generated in the inverter 5 to the outside can be reduced.

In a configuration in which the housing and the inverter cover 7 are electrically connected to each other only by the bolts 8, if conduction (conductivity) between the housing and the inverter cover 7 obtained by the bolts 8 are insufficiently obtained for some reasons (e.g., partial corrosion of the bolts 8), a potential difference might be generated between the housing and the inverter cover 7.

In view of this problem, in the this invention, an electrical connecting part that electrically connects the housing and the inverter cover 7 to each other is provided in addition to the bolts 8, to prevent generation of a potential difference between the housing and the inverter cover 7 even in a case in which conductivity between the housing and the inverter cover 7 cannot be sufficiently obtained by the bolts 8. That is, in this embodiment, the end surface of the peripheral wall 61 of the inverter case 6 has a projection 63 of which an upper portion (upper surface) comes into contact with an opposed surface (bottom surface) of the inverter cover 7 when the inverter cover 7 is fixed to the inverter case 6. This projection 63 electrically connects the housing of the electric compressor 1 and the inverter cover 7 to each other.

Here, if the projection 63 is located toward the exterior of the inverter case 6 relative to the bolts 8 and/or the insulating gasket 9 (including, of course, a case in which the projection 63 is located between the bolts 8 and the insulating gasket 9), a pressing force applied to the insulating gasket 9 (a fastening pressure to the insulating gasket 9) caused by screwing of the bolts 8 has less effect especially on an outer edge region of the insulating gasket 9, so that sealing performance between the housing (inverter case 6) and the inverter cover 7 might be reduced. If the projection 63 is located toward the exterior of the inverter case 6 relative to the bolts 8 and the insulating gasket 9, the projection 63 might corrode, for example, so that conductivity between the housing and the inverter cover 7 might fail to be sufficiently obtained by the projection 63.

Thus, in this embodiment, the projection 63 is disposed toward the interior of the inverter case 6 relative to the bolts 8 and the insulating gasket 9, so that electrical connection between the housing and the inverter cover 7 can be obtained with stability, and a decrease in sealing performance between the housing and the inverter cover 7 caused by forming the projection 63, that is, the electrical connecting part, can be reduced.

Specifically, as illustrated in FIG. 2, the projection 63 according to this embodiment is formed near the bolt hole 62f and toward the interior relative to the bolt hole 63f (on an inverter accommodating side) on the end surface of the peripheral wall 61 of the inverter case 6. Furthermore, as illustrated in FIGS. 3 and 4, the projection 63 according to this embodiment is located toward the interior relative to the bolt hole 62f on the end surface of the peripheral wall 61 of the inverter case 6 and toward the interior relative to the inner edge portion 9a of the annular insulating gasket 9.

That is, in this embodiment, the projection 63 electrically connecting the housing (inverter case 6) of the electric compressor 1 and the inverter cover 7 is located toward the interior of the inverter case 6 relative to the bolts 8 securely fastening the inverter cover 7 to the inverter case 6 and the insulating gasket 9 sealing a gap between the inverter case 6 and the inverter cover 7.

The projection 63 is disposed near one of a plurality of bolt fastening portions (bolt fastening locations). In other words, the housing (inverter case 6) of the electric compressor 1 and the inverter cover 7 are electrically connected to each other by one electrical connecting part disposed between the housing and the inverter cover 7 in such a manner that the electrical connecting part is discontinuous along the circumference of the housing of the electric compressor 1, in addition to the bolts 8.

As described above, in this embodiment, the projection 63 electrically connecting the housing (inverter case 6) of the electric compressor 1 and the inverter cover 7 to each other is provided in addition to the bolts 8. Furthermore, the projection 63 is disposed toward the interior of the inverter case 6 relative to the bolts 8 and the insulating gasket 9.

Thus, even in a case in which conductivity between the housing and the inverter cover 7 with the bolts 8 decreases, electrical connection between the housing and the inverter cover 7 can be obtained with stability. It is also possible to reduce a decrease in pressing force to the insulating gasket 9 (a fastening pressure of the insulating gasket 9) due to the presence of the projection 63, which leads to a decrease in sealing performance between the housing and the inverter cover 7.

The annular insulating gasket 9 has the bolt insertion holes 91 (91a to 91g) through which the bolts 8 are inserted, and the inner edge portion 9a of the annular insulating gasket 9 is located toward the interior of the inverter case 6 relative to the bolts 8, and toward the exterior of the inverter case 6 relative to the projection 63, and the outer edge portion 9b of the annular insulating gasket 9 is located toward the exterior of the inverter case 6 relative to the bolts 8. In other words, the insulating gasket 9 has the bolt insertion holes 91a to 91g through which the bolts 8 are inserted and seals a gap between the housing and the inverter cover 7 at both locations toward the interior and the exterior of the inverter case 6 relative to the bolts 8. The inner edge portion 9a of the insulating gasket 9 is located outside the projection 63, and an influence of the projection 63 on sealing performance of the insulating gasket 9 is reduced. In this manner, a decrease in sealing performance between the housing and the inverter cover 7 can be reduced, and a pressing force can be effectively applied to the insulating gasket 9. In addition, since the gap between the housing and the inverter cover 7 is sealed outside the bolts 8, corrosion of the bolts 8, for example, can be reduced.

The projection 63 is disposed only at one location near the bolt fastening portion, and is discontinuous along the circumference of the housing of the electric compressor 1. Thus, a decrease in pressing force to the insulating gasket 9 (a fastening pressure to the insulating gasket 9) can be also reduced.

The preferred embodiment of the present invention has been described above. However, the present invention is not limited to the embodiment described above, and further modification or other variations may be made based on the technical concept of the present invention. Some variations will be described below.

For example, in the above embodiment, the bolts 8 are inserted into the bolt insertion holes 91a to 91g of the insulating gasket 9, and the gap between the housing and the inverter cover 7 is sealed at both locations toward the interior and the exterior of the inverter case 6 relative to the bolts 8. However, the present invention is not limited to this example. The insulating gasket 9 only needs to be located outside the projection 63, and may be disposed between the bolts 8 and the projection 63, for example. In such a case, a decrease in pressing force to the insulating gasket 9 (a fastening pressure to the insulating gasket 9) due to the presence of the projection 63 can be reduced. To prevent corrosion of the bolts 8, for example, the insulating gasket 9 preferably includes a portion that seals the gap between the housing and the inverter cover 7 at the location toward the exterior of the inverter case 6 relative to the bolts 8.

In the above embodiment, the projection 63 is disposed near the bolt hole 63f, that is, only one of the bolt fastening portions (bolt fastening locations). However, the present invention is not limited to this example, and the projection 63 may be disposed near each of two or more or all of the bolt fastening portions. That is, the projection 63 only needs to be disposed near at least one of the bolt fastening portions. In such cases, the electrical connecting part electrically connecting the housing of the electric compressor 1 and the inverter cover 7 to each other is discontinuous along the circumference of the housing of the compressor 1, so that a decrease in pressing force to the insulating gasket 9 can be reduced.

In the above embodiment, the projection 63 serving as the electrical connecting part electrically connecting the housing of the electric compressor 1 and the inverter cover 7 to each other is formed in the housing (inverter case 6). However, the present invention is not limited to this example, and the projection as the electrical connecting part may be formed in the inverter cover 7 or may be formed in each of the housing and the inverter cover 7.

### REFERENCE SYMBOL LIST

1 Electric compressor
2 Compression mechanism
3 Electric motor
4 Main body case (housing)
5 Inverter
6 Inverter case (housing)
7 Inverter cover
8 Bolt
9 Insulating gasket (sealing member)
9a Inner edge portion of insulating gasket
9b Outer edge portion of insulating gasket
63 Projection (electrical connecting part)
91 (91a to 91g) Bolt insertion hole (bolt insertion part)

1. An electric compressor comprising:
a housing made of a metal, configured to accommodate a compression mechanism and an electric motor for driving the compression mechanism, and having an inverter accommodating portion accommodating an inverter for driving the electric motor;
an inverter cover made of a metal, covering the inverter accommodated in the inverter accommodating portion, and having a peripheral portion securely fastened to the housing with bolts;
an insulating sealing member disposed between the housing and the inverter cover and configured to seal a gap between the housing and the inverter cover; and
an electrical connecting part configured to electrically connect the housing and the inverter cover to each other,
wherein the electrical connecting part is located toward the interior of the inverter accommodating portion relative to the bolts and the insulating sealing member.

2. The electric compressor according to claim 1, wherein the insulating sealing member comprises a portion for sealing the gap between the housing and the inverter cover at a location toward the exterior of the inverter accommodating portion relative to the bolts.

3. The electric compressor according to claim 1, wherein
the insulating sealing member is formed annularly and comprises annular bolt insertion parts in which the bolts are inserted,
an inner edge portion of the insulating sealing member is located toward the interior of the inverter accommodating portion relative to the bolts and toward the exterior of the inverter accommodating portion relative to the electrical connecting part, and
an outer edge portion of the insulating sealing member is located toward the exterior of the inverter accommodating portion relative to the bolts.

4. The electric compressor according to claim 1, wherein the electrical connecting part is disposed near a bolt fastening portion.

5. The electric compressor according to claim 1, wherein the housing and the inverter cover are in contact with each other through at least one of a projection serving as the electrical connecting part and provided in the housing and a projection serving as the electrical connecting part and provided in the inverter cover, so that the housing and the inverter cover are electrically connected to each other.
